(19) United States
(12) Patent Application Publication
(10) Pub. No.: US 2013/0304508 A1
(43) Pub. Date: Nov. 14, 2013

(54) System and Method for Collaborative Patient Engagement

(71) Applicant: Shahid N. Shah, Silver Spring, MD (US)

(72) Inventor: Shahid N. Shah, Silver Spring, MD (US)

(73) Assignee: NETSPECTIVE COMMUNICATIONS LLC, Silver Spring, MD (US)

(21) Appl. No.: 13/871,107

(22) Filed: Apr. 26, 2013

Related U.S. Application Data
(60) Provisional application No. 61/646,744, filed on May 14, 2012.

(51) Int. Cl. G06F 19/00

(52) U.S. Cl. CPC G06F 19/322
USPC 705/3

(57) ABSTRACT

A system for facilitating collaborative engagement among a plurality of entities. The system includes a common interactive platform for allowing the various entities to interact collaboratively and with the system. The entities include one or more of a patient, healthcare provider, and the healthcare provider related entities, and a patient related entity, the patient related entity bearing a relationship with the patient as defined by an associated relationship identity number associated with the patient related entity in association with the respective patient. The system further includes or is coupled to a patient information database and a clinical data repository. The system further includes a processing unit to process stored programmed instructions for enabling collaborative engagement among the entities.

### CROSS-REFERENCE TO RELATED APPLICATIONS

This application claims priority to U.S. provisional application no. 61/646,744 filed on May 14, 2012, the complete disclosure of which, in its entirety, is herein incorporated by reference.

### BACKGROUND

1. Technical Field

The embodiments herein generally relate to health management, and more particularly to collaborative patient engagement by healthcare providers, healthcare provider related entities, patients and patient related, and other entities for health management of the patients.

2. Description of the Related Art

Healthcare networks include a variety of entities such as patients, patient related entities, health care providers including for example hospitals, doctors, physicians, caretakers and the like, health care provider related entities and several other similar entities. These entities rely on one another for the information necessary to perform their respective roles because individual care is delivered through numerous locations and numerous persons and organizations that may be related or unrelated. As a result, a plethora of healthcare information storage, retrieval, and collaboration systems are required to support the flow of information among the various entities. Several such methods and systems exist for health information management and flow. There is, however, still a need for an improved system and a method for collaborative patient engagement.

### SUMMARY

In view of the foregoing, an embodiment herein provides a system for facilitating collaborative engagement among a plurality of entities. The system includes a common interactive platform for allowing the various entities to interact collaboratively and with the system. The entities include one or more of a patient, healthcare provider, healthcare provider related entity, and a patient related entity, the patient related entity bearing a relationship with the patient as defined by an associated relationship identity number associated with the patient related entity in association with the respective patient. The system further includes or is coupled to a patient information database to contain information relevant to the patient including demographic information, and health related information for the patient, and information pertinent to a healthcare provider, and a healthcare provider related entity associated with the patient in order to develop or manage health plans for the patient. The system further includes a clinical data repository to store information collated by the plurality of healthcare providers, and the healthcare provider related entities as obtained from the patients and the patient related entities, wherein the clinical data repository is coupled to the patient information database and retrieves information partially from the patient related database. The plurality of healthcare providers and the healthcare provider related entities collaboratively engage with one another through the interactive platform to access and maintain the clinical data repository. The clinical data repository further includes guidelines and manual reports prescribed by the healthcare providers and the healthcare provider related entities to the associated patients for health planning and management. The system further includes a processing unit to process stored programmed instructions for enabling collaborative engagement among the entities. The processing unit includes or is coupled to a health assessment module configured to assess health of the patients that are subscribed to a service provided by the system. The health assessment is performed based on records obtained from the associated healthcare providers and the healthcare provider related entities for the patients from one or more of the patient information database and the clinical data repository. The processing unit further includes a health planning module to recommend medical procedures and guidelines for the patients, the health planning module further defines a baseline for appropriateness of performance to evaluate performance below the recommended guidelines. The processing unit further includes a tracking module to monitor the patients for performance toward the recommended guidelines in view of an health assessment output as obtained from the health assessment module. The processing unit further includes an alarm module to raise an alarm when the tracking module identifies the performance below the baseline. The processing unit further includes a relationship management module to associate patient related entities with the respective patients and define a nature of association between the patients and the respective patient related entities. The processing unit further includes a scoring module coupled to the relationship management module to define a relational score for the patient related entities. The relational score considers a cumulative effect of the nature of association with the patient and familiarity of the patient related entity with a problem associated with the patient for which the health planning is sought, wherein the relational score is defined based on input received from the patients, patient related entities, health care providers, and the health care provider related entities. The system communicates with the patient related entities associated with the respective patients about non-performance of the patients when the performance goes beyond an acceptance range of the baseline, further wherein the related entities are selected based on an association of the related entities with the patients and a relational score associated with the patient related entities.

An embodiment herein provides a method for facilitating collaborative engagement among a plurality of entities including health providers, healthcare provider related entities, patients and patient related entities. The method includes assessing health of the patients, wherein the health assessment is performed based on records obtained from the associated healthcare providers and the healthcare provider related entities for the patients from one or more of a patient information database and a clinical data repository, wherein the clinical data repository and the patient information database stores information pertinent to the patients including demographic information, and health related information of the patients, and information pertinent to the healthcare providers and the healthcare provider related entities associated with the patients in order to develop or manage health plans for the patients, and information collated by the healthcare providers and the healthcare provider related entities as obtained from the patients and the patient related entities. The clinical data repository is coupled to the patient information database and retrieves information partially from the patient information database. The healthcare providers and the healthcare provider related entities collaboratively engage with one another through an interactive platform to access and maintain the clinical data repository. The clinical data repository further includes guidelines and manual reports prescribed by the healthcare providers and the healthcare provider related entities to the associated patients for health planning and management. The patient related entities and the patients further collaboratively engage with the healthcare providers and the healthcare provider related entities through the interactive platform. The method may further include developing a health planning recommendation including medical procedures and guidelines for the patients. The health planning recommendation defines a baseline for appropriateness of performance to evaluate performance beyond the recommended guidelines. The method may include monitoring the patients for performance toward the recommended guidelines in view of an health assessment output as obtained from the health assessment module. The method may include generating an alarm in case the monitored performance is beyond an acceptance range of the baseline. The method may include communicating about the performance of the patients to the respective patient related entities, wherein the patient related entities are dynamically selected based on an associated relational score and nature of association of the patient related entities with the respective patients. The patient related entities bear a relationship with the respective patients as defined by an associated relationship identity number associated with each of the patient related entities in association with the respective patients.

An embodiment herein provides a program storage device readable by computer, and comprising a program of instructions executable by the computer to perform a method for facilitating collaborative engagement among a plurality of entities including health care providers, patients and patient related entities. The method includes assessing health of the patients, wherein the health assessment is performed based on records obtained from the associated healthcare providers and the healthcare provider related entities for the patients from one or more of a patient information database and a clinical data repository, wherein the clinical data repository and the patient information database stores information pertinent to the patients including demographic information, and health related information of the patients, and information pertinent to the healthcare providers and the healthcare provider related entities associated with the patients in order to develop or manage health plans for the patients, and information collated by the healthcare providers and the healthcare provider related entities as obtained from the patients and the patient related entities. The clinical data repository is coupled to the patient information database and retrieves information partially from the patient information database. The healthcare providers and the healthcare provider related entities collaboratively engage with one another through an interactive platform to access and maintain the clinical data repository. The clinical data repository further includes guidelines and manual reports prescribed by the healthcare providers and the healthcare provider related entities to the associated patients for health planning and management. The patient related entities and the patients further collaboratively engage with the healthcare providers and the healthcare provider related entities through the interactive platform. The method may further include developing a health planning recommendation including medical procedures and guidelines for the patients. The health planning recommendation defines a baseline for appropriateness of performance to evaluate performance beyond the recommended guidelines. The method may include monitoring the patients for performance toward the recommended guidelines in view of an health assessment output as obtained from the health assessment module. The method may include generating an alarm in case the monitored performance is beyond an acceptance range of the baseline. The method may include communicating about the performance of the patients to the respective patient related entities, wherein the patient related entities are dynamically selected based on an associated relational score and nature of association of the patient related entities with the respective patients. The patient related entities bear a relationship with the respective patients as defined by an associated relationship identity number associated with each of the patient related entities in association with the respective patients.

### BRIEF DESCRIPTION OF THE DRAWINGS

The embodiments herein will be better understood from the following detailed description with reference to the drawings, in which:

FIG. 1 is a block diagram illustrating an example of an environment or an ecosystem in which various embodiments herein may operate;

FIG. 2 is a block diagram illustrating an example of a system among other things configured to facilitate collaborative patient engagement according to an embodiment herein;

FIG. 3 is a block diagram illustrating an example of a system among other things configured to facilitate collaborative patient engagement according to an embodiment herein;

FIG. 4 is a flow chart illustrating an example of a method for collaborative patient engagement according to an embodiment herein;

FIG. 5 is a flow chart illustrating an example of a method for collaborative patient engagement according to an embodiment herein;

FIG. 6 is a block diagram illustrating an example of a hardware environment for practicing the embodiments depicted in FIGS. 1 through 5.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

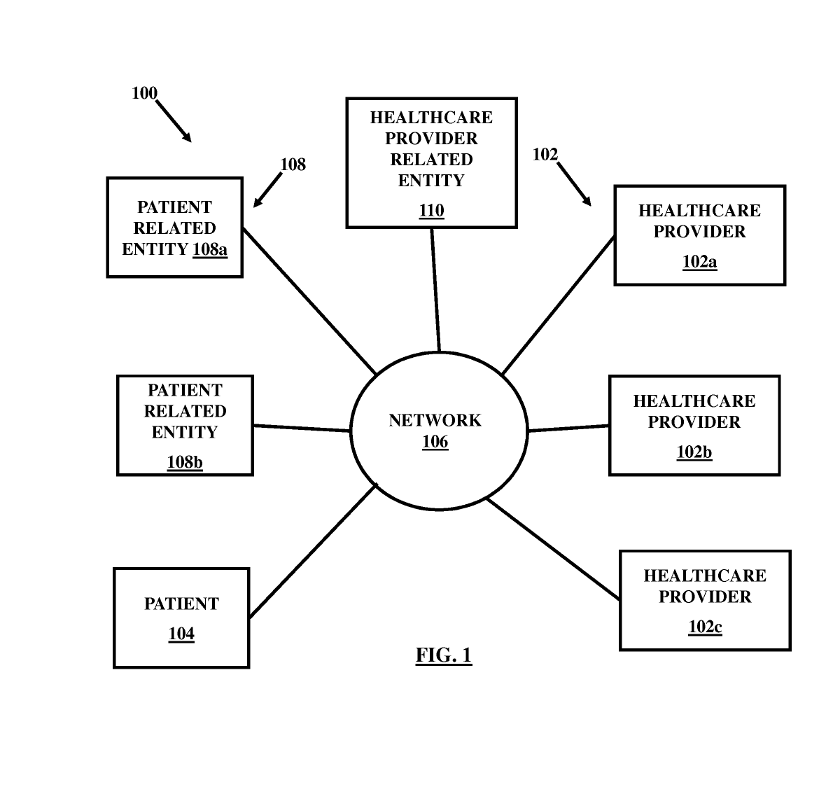

In the following detailed description, reference is made to the accompanying drawings which form a part hereof, and in which is shown by way of illustration specific embodiments in which the embodiments herein may be practiced. These embodiments, which are also referred to herein as “examples,” are described in sufficient detail to enable those skilled in the art to practice the embodiments herein, and it is to be understood that the embodiments may be combined, or that other embodiments may be utilized and that structural, logical, and electrical changes may be made without departing from the scope of the embodiments herein. Referring now to the drawings, and more particularly to FIGS. 1 through 6, where similar reference characters denote corresponding features consistently throughout the figures, there are shown preferred embodiments.

FIG. 1 illustrates generally, but not by way of limitation, among other things, an example of an environment or architecture or an ecosystem 100 in which various embodiments herein may operate. As illustrated in FIG. 1, the environment 100 constitutes a plurality of healthcare providers 102a, 102b, and 102c together referred to as 102, communicatively in connection with a patient 104 over a network 106. In addition, a plurality of patient related entities 108a, and 108b, referred to as 108 together and healthcare provider related entities 110 are also communicatively coupled over the network 106 with the plurality of healthcare providers 102. In an embodiment, the interconnected network of the patient 104, the plurality of healthcare providers 102, and the plurality of patient related entities 108 and the healthcare provider related entities 110 together provide a system or architecture providing a facility for collaborative patient engagement and patient health planning along with the healthcare providers 102, the patient related entities 108, and the healthcare provider related entities 110. This can be achieved using a collaborative engagement model as shown in FIG. 1 among various entities 102, 104, 108, and 110. The healthcare provider related entities 110 may include for example nutritionists, exercise coaches, pharmacists, drug companies, insurance payers, and other entities that aren't healthcare providers 102 but are related more to the health providers 102 than to the patients 104.

In an embodiment, a patient related entity such as 108a can be a relative of a patient, a friend of a patient, or a neighbor of a patient, or any other person, individual, or association or group having some interests in the health planning of the patient 104. In an embodiment, the patient related entity such as 108a can be a financial institution or a bank or an insurance company interested in understanding or knowing the health status and planning of the patient 104.

In an embodiment, a healthcare provider such as 102a can be a doctor, physician, surgeon, health planning agency, health care unit, care provider, or any other similar individual or firm, center, or association capable or authorized to guide the patient 104 in terms of health planning and health caring.

In an embodiment, the healthcare provider such as 102a and the healthcare provider related entities 110 can issue health planning guidelines that can be in the form of medical prescriptions, health tips, diagnostic guidelines, dietary control habits, food and nutritional guidelines, disease prevention and control guidelines, or in several other forms. The health planning can be aimed to inform and educate the patient 104 and the patient related entities 108 about health and health issues of the patient 104. The health planning can be aimed at identifying causes of the health issues associated with the patient 104 and providing guidelines and recommendations for their cure. The health planning by the health care providers 102 and the healthcare provider related entities 110 can be aimed at promoting and encouraging health awareness and healthy behaviors. The health care providers 102 and the healthcare provider related entities 110 can develop a center for assuring health services accessibility. In addition, the health care providers 102 and the healthcare provider related entities 110 develop policies, guidelines and plans for a healthy environment by providing health services to the patients similar to the patient 104.

In accordance with various embodiments, the health planning guidelines issued by the healthcare providers 102 and the healthcare provider related entities 110 can be accessed by the patient 104 and the patient related entities 108 so that they can track their compliance for performance by the patient 104. Also, the healthcare providers 102 and the healthcare provider related entities 110 can access and/or seek feedback from the patient 104 and/or the patient related entities 108 to understand patient performance against the issued healthcare planning guidelines. Thus, the entire networked architecture 100, as shown in FIG. 1, facilitates a collaborative patient engagement platform. In an embodiment, the patient 104 can be linked to only one healthcare provider (e.g., 102a or 102b individually) such as a hospital or a physician or one healthcare provider related entity 110. In another embodiment, the patient 104 can be linked to several healthcare providers 102 and the healthcare provider related entities 110. In such cases, the several healthcare providers 102 and the healthcare provider related entities 110 can access patient related information and patient performance among themselves internally also. The several healthcare providers 102 and the healthcare provider related entities 110 can collaboratively work for the health of the patient 104.

The network 106 can be a wireless or a wired network. The network 106 can operate as a communications network configuring communication among the healthcare providers 102, the healthcare provider related entities 110, patient 104, and the patient related entities 108. In an embodiment, the network 106 can be the Internet. The healthcare providers 102, healthcare provider related entities 110, patient 104, and the patient related entities 108 can be distributed over a wide area and can connect remotely among themselves over the network 106.

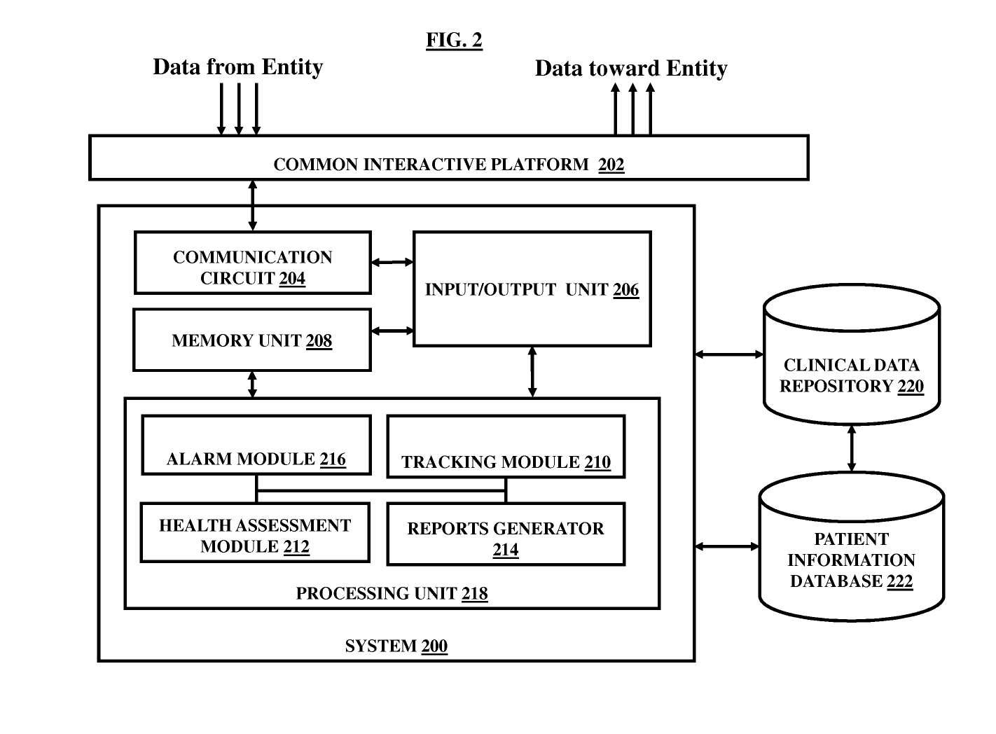

FIG. 2, with reference to FIG. 1, illustrates generally, but not by way of limitation, among other things, an example of a computer implemented system 200 configured to facilitate collaborative engagement among various entities as shown in FIG. 1 for tracking, and monitoring patient performance regarding health and configured to be included within the ecosystem 100.

In an embodiment, the system 200 operates as a server-based system with centralized storage and remote access to the patient 104, patient related entities 108, healthcare providers 102, and the healthcare provider related entities 110. In an embodiment, the system 200 can provide a common interactive platform 202 for the patient 104, patient related entities 108, healthcare providers 102, and the healthcare provider related entities 110 (hereafter referred to as entities together). The common interactive platform 202 also referred to as platform 202 for simplicity of description serves as an access point for the various entities.

The system 200 includes a communication circuit 204. The communication circuit 204 can be configured to communicatively couple the entities with the system 200. The system 200 can include an input/output unit 206 configured to be coupled to the communication circuit 204. The input/output unit 206 can be configured to receive an input external from the system 200 such as from the entities or generate an output or communicate an output generated within the system 200, wherein the output can be configured to be received by the entities such as the patient 104 or the patient related entity 108 or the healthcare provider 102 or the healthcare provider related entities 110. The system 200 can include a memory unit 208 for storing programmed instructions within the system 200.

In an embodiment, the system 200 can include or be coupled to a patient information database 222. The patient information database 222 contains information that is relevant to the patient 104 such as his demographic information and the health information of the patient 104. The patient information database 222 can also store data associated with medical history or ongoing medical treatments of the patient 104. In an embodiment, information regarding one or more of the healthcare providers 102, and the healthcare provider related entities 110 associated with the patient 104 for health planning may also be stored in the patient information database 222. In accordance with an embodiment, the patient information database 222 can be a repository of the entire information of the patient 104 relevant for health planning, monitoring, tracking, and engagement. In an embodiment, any of the entities such as the patient 104 or the patient related entity 108 or the healthcare provider 102 or the healthcare provider related entities 110 can have an access to the patient information database 222. In an embodiment, only authorized persons can access the patient information database 222. In an embodiment, several healthcare providers 102 and the healthcare provider related entities 110 may collaboratively engage with the patient 104 or the patient related entities 108 to monitor patient health and performance for a set of defined standards. The set of defined standards may be defined by any of the healthcare providers 102 and the healthcare provider related entities 110 based on a patient health level and such other parameters. The set of defined standards may, for example, include dietary limitations, food guidelines, regular medications, exercise and fitness guidelines and limitations, and the like.

The system 200 can include or be coupled to a clinical data repository 220. The clinical data repository 220 may include health related information collated by the healthcare providers 102 and the healthcare provider related entities 110 and that may be referred by the patient 104 or the patient related entities 108 from time to time. In an embodiment, the clinical data repository 220 may include guideline and manual documents that can be prescribed by the healthcare providers 102 and the healthcare provider related entities 110 to the patient 104.

In an embodiment, the system 200 can include a processing unit 218. The processing unit 218 can be configured to process the programmed instructions as stored in the memory unit 208 for enabling a collaborative engagement through the system 200. In an embodiment, the processing unit 218 can include a health assessment module 212. The health assessment module 212 can be configured to assess health levels of the patient 104 assuming that the patient 104 is subscribed to a service provided through the system 200. In an embodiment, the health assessment can be performed based on the records obtained from the associated healthcare provider such as 102a and the healthcare provider related entities 110 for the patient 104. In an embodiment, the patient provided information or information provided by the patient related entity 108 for the patient 104 can also be included as a source of data for health assessment of the patient 104 by the health assessment module 212.

In an embodiment, the system 200 can include a tracking module 210. The tracking module 210 is capable of monitoring the patient 104 for performance based on the recommendations or suggestions developed as a result of a health assessment of the patient 104 as performed by the health assessment module 212. In an embodiment, any recommendation or suggestion from the healthcare provider 102a and the healthcare provider related entities 110 associated with the patient 104 can also be considered as a basis for monitoring or tracking the patient performance in light of the suggestions or the recommendations.

In case the patient 104 defaults in performance, the patient 104, or the patient related entity 108 or the associated healthcare provider 102 and the healthcare provider related entities 110 can be informed on a regular basis such as daily, weekly, monthly, and the like. In an embodiment, a report generator 214 included within the system 200 can be configured to generate reports that provide an assessment of the performance of the patient 104 based on an output generated by the tracking module 210. In an embodiment, the reports can be accessed by the patient 104, healthcare provider 102, and the healthcare provider related entities 110 or the patient related entity 108 when desired. In an embodiment, the reports can be automatically forwarded to the patient 104, or the patient related entity 108, or the healthcare provider 102 or the healthcare provider related entities 110 periodically. This may enable a collaborative engagement of the entities interested and concerned for the health of the patient 104.

In an embodiment, the system 200 may include an alarm module 216 configured to generate an alarm, a warning or an alert to the patient 104, or the patient related entity 108, or the healthcare provider 102 or the healthcare provider related entities 110. In an embodiment, the alarm module 216 may be programmed to generate alarms if the performance by the patient 104 goes out of a specified range. For example, if the patient 104 is allowed or prescribed by the healthcare provider 102a or the healthcare provider related entities 110 to use a specified medicine at least thrice a day and not more than five times a day, and the system 200 monitors the patient 104 to be medicated less than the lower limit (e.g., three times a day) or more than the upper limit (five times a day), an alert may be generated by the alarm module 216 and sent to the patient 104 or the patient related entity 108 or the healthcare provider 102 or the healthcare provider related entities 110. In some embodiments, the alarm module 216 may be programmed to generate the alarms based on defined preprogrammed instructions that can be stored in the memory unit 208. The alarm module 216 can be configured to be coupled to the tracking module 210 so that the output generated by the tracking module 210 in terms of compliance or non-compliance by the patient 104 for the recommendation or the patient performance can be used by the alarm module 216 to decide if a criteria of generating the alarm or alert is met or not. If the alarm module 216 decides and calculates that the criteria are met, then the alert can be sent.

In an embodiment, the alert can be sent to a mobile phone, cellular device, pager, computational unit, or any other similar device. In an embodiment, the alert can be sent in the form of a short message (SMS), a mobile phone text message, an audible sound, a vibration, a visual display, an instant message, or any other form of reminder or alert.

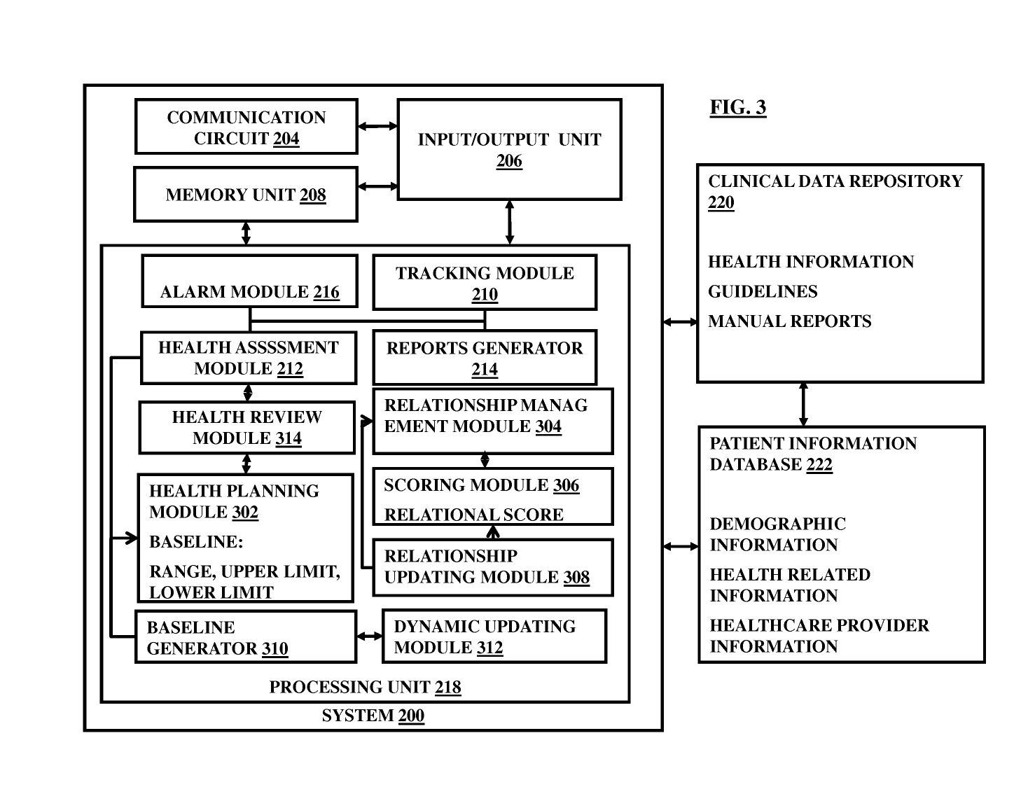

FIG. 3, with reference to FIGS. 1 through 2, illustrates a detailed diagram of the computer implemented system 200 of FIG. 2 in accordance with an embodiment herein. The system 200 is configured to facilitate collaborative engagement among the various entities 102, 104, and 108 (shown in FIG. 1) for assessing health of the patients 104, developing health plans, tracking, and monitoring patient performance regarding health, and updating about performance compliance of the patients to the patient related entities 108, patients 104, and the health care providers 102.

The system 200 includes or is coupled to the common interactive platform 202 (shown in FIG. 2). The interactive platform 202 allows the various entities 102, 104, and 108 to interact collaboratively mutually and with the system 200. The entities 102, 104 and 108 may include one or more of the patients 104, healthcare providers 102, healthcare provider related entities 110 and patient related entities 108 as discussed above. The patient related entities 108 may bear relationships with the respective associated patients 104. The relationships may be defined by associated relationship identity numbers associated with the patient related entities 108 in association with the respective patients 104.

The system 200 is coupled to the clinical data repository 220 and the patient information database 222 as discussed above in conjunction with FIG. 2. The patient information database 222 contains information relevant to the patients 104 including demographic information, and health related information for the patients 104, and information pertinent to the healthcare providers 102 or the healthcare provider related entities 110 associated with the patients 103 in order to develop or manage health plans for the patients 104. The clinical data repository 220 stores information collated by the plurality of healthcare providers 102 and the healthcare provider related entities 110 as obtained from the patients 104 and the patient related entities 108. The clinical data repository 220 is coupled to the patient information database 222 and retrieves information partially from the patient related database 222. The plurality of healthcare providers 102 and the healthcare provider related entities 110 collaboratively engages with one another through the interactive platform 202 to access and maintain the clinical data repository 220. The clinical data repository 220 further includes guidelines and manual reports prescribed by the healthcare providers 102 or the healthcare provider related entities 110 to the associated patients 104 for health planning and management.

The system 200 includes the processing unit 218 to process stored programmed instructions for enabling collaborative engagement among the entities 102, 104, and 108. The processing unit 218 includes or is coupled to the health assessment module 212 configured to assess health of the patients 104 that are subscribed to a service provided by the system 200. The health assessment is performed based on records obtained from the associated healthcare providers 102 or the healthcare provider related entities 110 for the patients 104 from one or more of the patient information database 222 and the clinical data repository 220. The processing unit 218 further includes or is coupled to a health planning module 302 to recommend medical procedures and guidelines for the patients 104. The health planning module 302 further defines a baseline for appropriateness of performance to evaluate performance below the recommended guidelines. The baseline represents a performance standard desired from the patients 104 in accordance with the developed health plans and guidelines in light of the performed health assessment. Any performance below or above the baseline is considered as not fully compliant to the recommended health plans or considered as non-compliance of the health plans. A range or margin of appropriateness above and below the baseline may be defined such as to define a lower limit of appropriateness and an upper limit of appropriateness and the patients' performance within the lower and upper limit may also be considered as acceptable and appropriate.

The processing unit 218 may further include or may be coupled to the tracking module 210 to monitor the patients 104 for performance toward the recommended guidelines in view of health assessment output as obtained from the health assessment module 212. The alarm module 216 raises an alarm in case the tracking module 210 identifies the performance below the baseline or outside the defined range of appropriateness.

In some embodiments such as those illustrated in FIG. 3, the processing unit 218 may include or be coupled to a relationship management module 304 to associate the patient related entities 108 with the respective patients 104 and define a nature of association between the patients 104 and the respective patient related entities 108. In some cases, a patient may be associated with more than one patient related entities and each of them may bear a different relationship with the patient. For example, one of them may be a guardian or a parent while the other of them may be a friend. In such cases, the relationship management module 304 associates and considers the influence that the different relationships may bear on the patient. For example, in case of non-performance to the health plans by the patient, the system 200 may communicate to the guardian instead of communicating to the friend. However, in cases of a personal problem and upon a desire by the patient himself, the patient's non-performance may be communicated to the friend or spouse whoever is appropriate.

The relationship management module 304 includes or is coupled to a scoring module 306 to define a relational score for the patient related entities 108. The relational score considers a cumulative effect of the nature of association of the patient related entities 108 with the patients 104 and familiarity of the patient related entities 108 with a problem associated with the patient 104 for which the health planning is sought. The relational score is defined based on input received from the patients 104, patient related entities 108, and the health care providers 102. The relational score may, for example, be used to select a patient related entity out of the several patient related entities 108 for communication regarding non-performance or performance of the patients 104 or to send alerts based on monitoring of the performance of the patients 104. The system 200 communicates with the patient related entities 108 associated with the respective patients 104 about non-performance of the patients 104 when the performance goes beyond an acceptance range from the baseline. The related entities 108 are selected based on an association of the related entities 108 with the patients 104 and the relational scores associated with the patient related entities 108.

The system 200 may further include a relationship updating module 308 to evaluate the relationships between the patient related entities 108 and the respective patients 104 and evaluate the relational score associated with the patient related entities 108 and update the nature of association and the relational score associated with the entities 108 periodically. For example, if a friend relationship changes to that of a spouse, the updating module 308 may update the relationship.

The health assessment module 212 may include a health review module 314 to allow reviewing of the health assessment details from relevant healthcare providers and the healthcare provider related entities 110 individually and by health experts. The health assessment details are further communicated to the patient related entities 108 based on the relational score and the nature of association. For example, an entity with a higher score may be preferred for sending details about patient's health performance.

The health planning module 302 receives an input from the health assessment module 212 to recommend the medical procedures and guidelines for the patients. The health planning module 302 is coupled to a baseline generator 310. The input from the health assessment module 212 along with the medical knowledge data house stored in the clinical data repository 220 is used to define the baseline for appropriateness by the baseline generator 310. The baseline for appropriateness further identifies the range with the upper limit of appropriateness and the lower limit of appropriateness as mentioned above. The baseline generator 310 may be coupled to a dynamic updating module 312 configured to receive input from the clinical data repository 220 and the patient information database 222 continually to update the range of appropriateness and the baseline dynamically. The patient related entities 108 may be informed about the dynamic updates based on the relational score and the nature of association.

In an embodiment, the report generator 214 may be coupled to the tracking module 210, alarm module 216, and the health assessment module 212. The report generator 214 may be adapted to receive inputs from the tracking module 210 and the health assessment module 212 to generate reports regarding health planning and compliance by the patients 104. The reports may be used by the alarm module 216 to generate the alarm. The reports may further be communicated to the patient related entities 108 based on the nature of association and the relational score. The patient related entities 108 may include one or more of parents, guardians, kids, siblings, colleagues, teachers, caretakers, and doctors, and the like.

In some embodiments, the relational score may be defined based on parameters including one or more of natural relationship, familiarity of the patient related entities 108 with the medical problem of the patients 104, historical association of the patient related entities 108, age of the patient related entities 108, acceptance of the patient related entities 108 by the patients 104 as caretaker, affinity or proximity toward the patients 104 and ethical intent, and the like. A weightage may be associated with each of the parameters such that cumulative relational scores are defined based on relational scores for each of the parameters weighted with the respective weightage scores. The cumulative relational score for a patient may be used by the system 200 to define or update criteria for scoring of subsequent patient related entities. In some embodiments, historical records of the relational scores of the entities 108 scored in the past may be used to dynamically update subsequent scoring of the patient related entities 108 in real time.

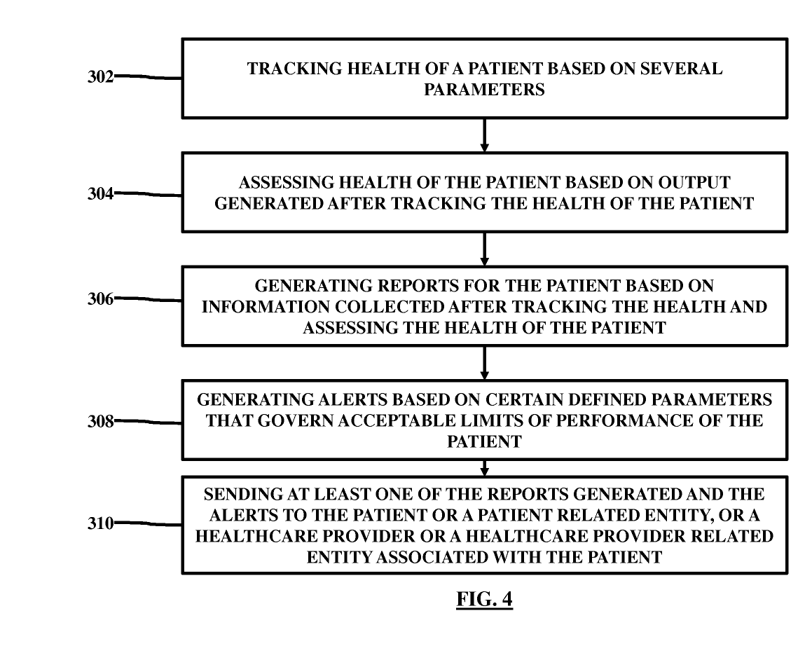

FIG. 4, with reference to FIGS. 1 through 3, illustrates a method flow diagram for facilitating collaborative patient engagement among the various entities. At step 302, the method can include tracking or monitoring the health of the patient 104 based on several parameters accumulated from the patient 104, the healthcare provider 102a and the healthcare provider related entities 110 associated with the patient 104, and the patient related entity 108. The tracking can be performed on a regular basis or can be time bound such as for a defined period of time. The tracking can be performed in order to make a health assessment or generate health plans for the patient 104.

At step 304, the method can include assessing the health of the patient 104 based on the output generated after tracking the health of the patient 104. At step 306, the method can include generating reports in the form of guidelines, manuals, recommendations, or suggestions for the patient 104 based on information collected after tracking the health and assessing the health of the patient 104. At step 308, the method can include generating alerts based on certain defined parameters that govern acceptable limits of performance of the patient 104. At step 310, the method can included sending at least one of the reports generated and the alerts to the patient 104 or the patient related entity 108, or the healthcare provider 102 or the healthcare provider related entities 110 associated with the patient 104.

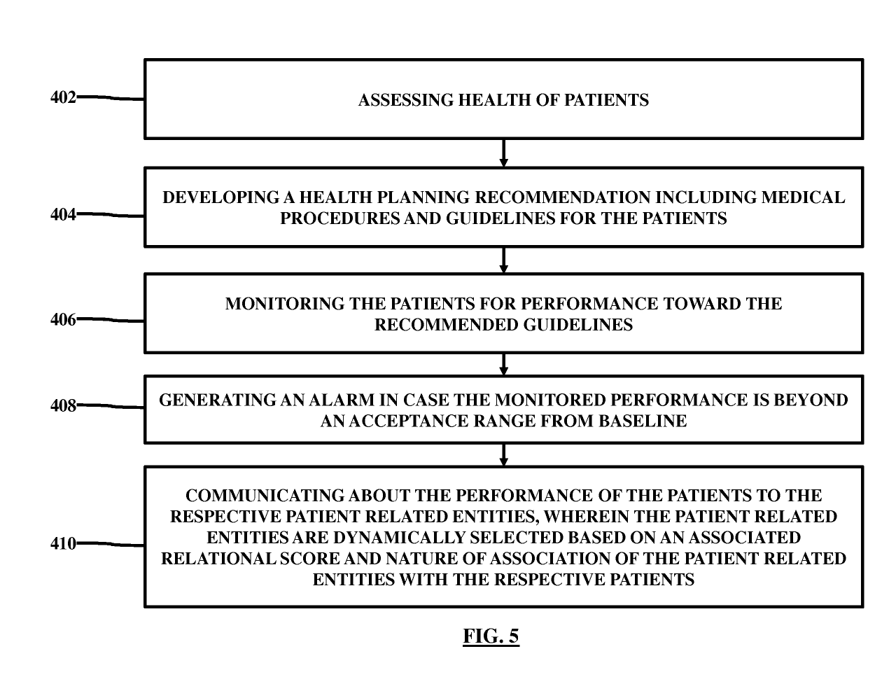

FIG. 5, with reference to FIGS. 1 through 4, illustrates a method flow diagram for facilitating collaborative patient engagement among the various entities 102, 104, and 108. At step 402, the method may include assessing health of the patients 104. The health assessment is performed based on records obtained from the associated healthcare providers 102 or the healthcare provider related entities 110 for the patients 104 from one or more of the patient information database 222 and the clinical data repository 220. The clinical data repository 220 and the patient information database 222 stores information pertinent to the patients 104 including demographic information, and health related information of the patients 104, and information pertinent to the healthcare providers 102 or the healthcare provider related entities 110 associated with the patients 102 in order to develop or manage health plans for the patients 104, and information collated by the healthcare providers 102 and the healthcare provider related entities 110 as obtained from the patients 104 and the patient related entities 108. The clinical data repository 220 is coupled to the patient information database 222 and retrieves information partially from the patient information database 222. The healthcare providers 102 and the healthcare provider related entities 110 collaboratively engage with one another through the interactive platform 202 to access and maintain the clinical data repository 220. The clinical data repository 220 further includes guidelines and manual reports prescribed by the healthcare providers 102 and the healthcare provider related entities 110 to the associated patients 104 for health planning and management. The patient related entities 108 and the patients 104 further collaboratively engage with the healthcare providers 102 and the healthcare provider related entities 110 through the interactive platform 202.

At step 404, the method may include developing a health planning recommendation including medical procedures and guidelines for the patients 104. The health planning recommendation may define a baseline for appropriateness of performance to evaluate performance beyond the recommended guidelines. At step 406, the method may include monitoring the patients 104 for performance toward the recommended guidelines in view of a health assessment output as obtained from the health assessment module 212. At step 408, the method may include generating an alarm in case the monitored performance is beyond an acceptance range from the baseline. At step 410, the method may include communicating about the performance of the patients 104 to the respective patient related entities 108 or the healthcare providers 102 or the healthcare provider related entities 110. The patient related entities 108 may be dynamically selected based on the associated relational score and nature of association of the patient related entities 108 with the respective patients 104. The patient related entities 108 bear a relationship with the respective patients 104 as defined by the associated relationship identity number associated with each of the patient related entities 108 in association with the respective patients 104.

The method may also include assigning the relational score to the patient related entities 108 in association with the respective patients 104 based on parameters including one or more of natural relationship, familiarity of the patient related entities 108 with the medical problem of the patients 104, historical association of the patient related entities 108, age of the patient related entities 108, acceptance of the patient related entities 108 by the patients 104 as caretaker, affinity or proximity toward the patients 104, and ethical intent, and the like. A weightage may be associated with each of the parameters such that a cumulative relational score is defined based on relational scores for each of the parameters weighted with the respective weightage scores.

The method may include using the cumulative relational score to define or update criteria for scoring of subsequent patient related entities. In an embodiment, historical records of the relational scores of the patient related entities 108 scored in the past may be used to dynamically update the subsequent scoring of the patient related entities 108 in real time. For example, if the historical records suggest that a high relationship score is assigned or preferred by the patients 104 to a friend for a particular disease ABC relative to the spouse, then such statistical records may be used to dynamically score the particular relationship for the particular disease in a defined way. In various embodiments, the patient related entities 108 may include one or more of parents, guardians, kids, siblings, colleagues, teachers, caretakers, and doctors such that each of them may be scored differently for assigning the relational score.

In some embodiments, the baseline for appropriateness further identifies a range with an upper limit of appropriateness and a lower limit of appropriateness. The method may further include updating the range of appropriateness and the baseline dynamically based on an input from the clinical data repository 220 and the patient information database 222 such that the patient related entities 108 are informed about the dynamic updates based on their relational score and the nature of association.

In accordance with various embodiments, various types of collaborative patient engagement may be facilitated by the ecosystem 100. In an embodiment, the ecosystem 100 may facilitate patient engagement of the type including ‘person-entered structured’ content. The ‘person-entered structured’ content may include records such as from electronic health or medical bank or any other similar source for example, electronic health records. In another embodiment, the ecosystem 100 may facilitate patient engagement of the type including ‘person-entered semi-structured’ content. The ‘person-entered semi-structured’ content may include records for example from a combination of databases and records in the form of free-text. In another embodiment, the ecosystem 100 may facilitate patient engagement of the type including ‘person-entered unstructured’ content. The ‘person-entered unstructured’ content may include records in the form of, for example, natural or free text (either by patient, their related entity, healthcare provider, or healthcare provider related entity). In another embodiment, the ecosystem 100 may facilitate patient engagement of the type including ‘lab-generated structured’ content for example biomarkers, biometric, etc. In another embodiment, the ecosystem 100 may facilitate patient engagement of the type including ‘device-generated structured’ content such as obtained from a plurality of medical devices automatically. In still other embodiments, the ecosystem 100 may facilitate patient engagement of any other type or of the type including any other type of content or a combination of those mentioned here.

In an example, the embodiments herein can include a computer program product configured to include a pre-configured set of instructions, which when performed, can result in actions as stated in conjunction with the method described above. In an example, the pre-configured set of instructions can be stored on a tangible non-transitory computer readable medium. In an example, the tangible non-transitory computer readable medium can be configured to include the set of instructions, which when performed by a device, can cause the device to perform acts similar to the ones described here.

The embodiments herein may also include tangible and/or non-transitory computer-readable storage media for carrying or having computer executable instructions or data structures stored thereon. Such non-transitory computer readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer executable instructions, associated data structures, and program modules represent examples of the program code means for executing steps of the methods disclosed herein. The particular sequence of such executable instructions or associated data structures represents examples of corresponding acts for implementing the functions described in such steps.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network 104). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can include both hardware and software elements. The embodiments that are implemented in software include but are not limited to, firmware, resident software, microcode, etc.

Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network 104 adapters may also be coupled to the system to enable the data processing system to become coupled to other data processing systems or remote printers or storage devices through intervening private or public network 104s. Modems, cable modem and Ethernet cards are just a few of the currently available types of network 104 adapters.

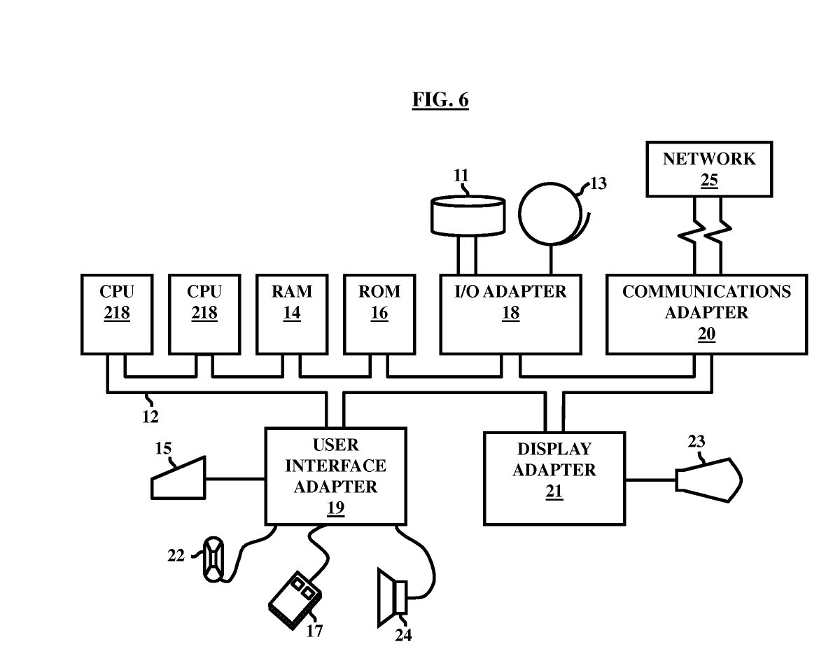

A representative hardware environment for practicing the embodiments herein is depicted in FIG. 6, with reference to FIGS. 1 through 5. This schematic drawing illustrates a hardware configuration of an information handling/computer system in accordance with the embodiments herein. The system comprises at least one processor or central processing unit (CPU) 218. The CPUs 218 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 106 or 25, and a display adapter 21 connects the bus 12 to a display device 23 which may be embodied as an output device such as a monitor, printer, or transmitter, for example.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A system for facilitating collaborative engagement among a plurality of entities, said system comprising:
a common interactive platform to allow said various entities to interact collaboratively and with said system, wherein said entities include one or more of a patient, a healthcare provider, healthcare provider related entities, and a patient related entity, said patient related entity comprising a relationship with said patient as defined by an associated relationship identity number associated with said patient related entity in association with said respective patient;
a patient information database to contain information relevant to said patient including demographic information, and health related information for said patient, and information pertinent to a healthcare provider or a healthcare provider related entity associated with said patient in order to develop or manage health plans for said patient;
a clinical data repository to store information collated by a plurality of healthcare providers and the healthcare provider related entities as obtained from said patients and said patient related entities, wherein said clinical data repository is coupled to said patient information database and retrieves information partially from said patient related database, wherein said plurality of healthcare providers and said healthcare provider related entities collaboratively engage with one another through said interactive platform to access and maintain said clinical data repository, wherein said clinical data repository further includes guidelines and manual reports prescribed by said healthcare providers and said healthcare provider related entities to said associated patients for health planning and management;
a processing unit to process stored programmed instructions for enabling collaborative engagement among said entities, wherein said processing unit includes or is coupled to:
a health assessment module configured to assess a health of said patients that are subscribed to a service provided by said system, wherein said health assessment is performed based on records obtained from said associated healthcare providers and said healthcare provider related entities for said patients from one or more of said patient information database and said clinical data repository;
a health planning module to recommend medical procedures and guidelines for said patients, said health planning module further defines a baseline for appropriateness of performance to evaluate performance below said recommended guidelines;
a tracking module to monitor said patients for performance toward said recommended guidelines in view of an health assessment output as obtained from said health assessment module;
an alarm module to raise an alarm in case said tracking module identifies said performance below said baseline;
a relationship management module to associate patient related entities with said respective patients and define a nature of association between said patients and said respective patient related entities; and
a scoring module coupled to said relationship management module to define a relational score for said patient related entities that considers a cumulative effect of said nature of association with said patient and familiarity of said patient related entity with a problem associated with said patient for which said health planning is sought, wherein said relational score is defined based on input received from said patients, patient related entities, and said health care providers,
wherein said system communicates with said patient related entities associated with said respective patients about non-performance of said patients when said performance goes beyond an acceptance range of said baseline, and
wherein said related entities are selected based on an association of said related entities with said patients and a relational score associated with said patient related entities.

2. The system of claim 1, further comprising a relationship updating module to evaluate said relationship between said patient related entities and said respective patients and said relational score associated with said patient related entities and update said nature of association and said relational score associated with said entities periodically.

3. The system of claim 1, wherein said health assessment module further comprises:
a health review module to allow reviewing of said health assessment details from said individual relevant healthcare providers and said healthcare provider related entities and health experts,
wherein said health assessment details are further communicated to said patient related entity based on said relational score and said nature of association.

4. The system of claim 1, wherein said health planning module receives an input from said health assessment module to recommend said medical procedures and guidelines for said patients, said health planning module coupled to a baseline generator, wherein said input along with medical knowledge data house stored in said clinical data repository being used to define said baseline for appropriateness by said baseline generator.

5. The system of claim 1, wherein said baseline for appropriateness further identifies a range with an upper limit of appropriateness and a lower limit of appropriateness.

6. The system of claim 5, wherein said baseline generator is coupled to a dynamic updating module configured to receive input from said clinical data repository and said patient information database continually to update said range of appropriateness and said baseline dynamically, and wherein said patient related entities are informed about said dynamic updates based on said relational score and said nature of association.

7. The system of claim 1, further comprising a report generator coupled to said tracking module, alarm module and said health assessment module, said report generator adapted to receive inputs from said tracking module and said health assessment module to generate reports regarding health planning and compliance by said patients, said reports being used by said alarm module to generate said alarm, said reports being further communicated to said patient related entities based on said nature of association and said relational score.

8. The system of claim 1, wherein said patient related entities include one or more of parents, guardians, kids, siblings, colleagues, teachers, caretakers, and doctors.

9. The system of claim 1, wherein said relational score is defined based on parameters including one or more of natural relationship, familiarity of said patient related entity with said medical problem of said patient, historical association of said patient related entity, age of said patient related entity, acceptance of said patient related entity by said patient as caretaker, affinity or proximity toward said patient and ethical intent, and wherein a weightage being associated to each of said parameters by said patient such that said cumulative relational scores are defined based on relational scores for each of said parameters weighted with said respective weightage scores.

10. The system of claim 9, wherein said cumulative relational score for a patient being used by said system to define or update criteria for scoring of subsequent patient related entities, and wherein a historical record of said relational scores of said patients scored in said past being used to dynamically update said subsequent scoring of said patients in real time.

11. A method for facilitating collaborative engagement among a plurality of entities including health providers, patients and patient related entities, said method comprising:
assessing a health of said patients, wherein said health assessment is performed based on records obtained from said associated healthcare providers and said healthcare provider related entities for said patients from one or more of a patient information database and a clinical data repository, wherein said clinical data repository and said patient information database stores information pertinent to said patients including demographic information, and health related information of said patients, and information pertinent to said healthcare providers and said healthcare provider related entities associated with said patients in order to develop or manage health plans for said patients, and information collated by said healthcare providers and said healthcare provider related entities as obtained from said patients and said patient related entities, wherein said clinical data repository is coupled to said patient information database and retrieves information partially from said patient information database, wherein said healthcare providers and said healthcare provider related entities collaboratively engage with one another through an interactive platform to access and maintain said clinical data repository, and wherein said clinical data repository further includes guideline and manual reports prescribed by said healthcare providers and said healthcare provider related entities to said associated patients for health planning and management, said patient related entities and said patients further collaboratively engaging with said healthcare providers and said healthcare provider related entities through said interactive platform;
developing a health planning recommendation including medical procedures and guidelines for said patients, said health planning recommendation defines a baseline for appropriateness of performance to evaluate performance beyond said recommended guidelines;
monitoring said patients for performance toward said recommended guidelines in view of an health assessment output as obtained from said health assessment module;
generating an alarm when said monitored performance is beyond an acceptance range of said baseline; and
communicating information about said performance of said patients to said respective patient related entities, wherein said patient related entities are dynamically selected based on an associated relational score and nature of association of said patient related entities with said respective patients,
wherein said patient related entities bear a relationship with said respective patients as defined by an associated relationship identity number associated with each of said patient related entities in association with said respective patients.

12. The method of claim 11, further comprising assigning said relational score to said patient related entities in association with said respective patients based on parameters including one or more of natural relationship, familiarity of said patient related entity with said medical problem of said patient, historical association of said patient related entity, age of said patient related entity, acceptance of said patient related entity by said patient as caretaker, affinity or proximity toward said patient, and ethical intent, wherein a weightage is associated with each of said parameters such that a cumulative relational score is defined based on relational scores for each of said parameters weighted with said respective weightage scores.

13. The method of claim 12, further comprising using said cumulative relational score to define or update criteria for scoring of subsequent patient related entities, wherein a historical record of said relational scores of said patient related entities scored in said past being used to dynamically update said subsequent scoring of said patient related entities in real time.

14. The method of claim 11, wherein said patient related entities include one or more of parents, guardians, kids, siblings, colleagues, teachers, caretakers, and doctors, each of them being scored differently for assigning said relational score.

15. The method of claim 11, wherein said baseline for appropriateness further identifies a range with an upper limit of appropriateness and a lower limit of appropriateness, said method further comprising updating said range of appropriateness and said baseline dynamically based on an input from said clinical data repository and said patient information database, and wherein said patient related entities are informed about said dynamic updates based on their relational score and said nature of association.

16. A program storage device readable by computer, and comprising a program of instructions executable by said computer to perform a method for facilitating collaborative engagement among a plurality of entities including health care providers, patients and patient related entities, said method comprising:
assessing a health of said patients, wherein said health assessment is performed based on records obtained from said associated healthcare providers and said healthcare provider related entities for said patients from one or more of a patient information database and a clinical data repository, wherein said clinical data repository and said patient information database stores information pertinent to said patients including demographic information, and health related information of said patients, and information pertinent to said healthcare providers and said healthcare provider related entities associated with said patients in order to develop or manage health plans for said patients, and information collated by said healthcare providers and said healthcare provider related entities as obtained from said patients and said patient related entities, wherein said clinical data repository is coupled to said patient information database and retrieves information partially from said patient information database, wherein said healthcare providers and said healthcare provider related entities collaboratively engage with one another through an interactive platform to access and maintain said clinical data repository, and wherein said clinical data repository further includes guideline and manual reports prescribed by said healthcare providers and said healthcare provider related entities to said associated patients for health planning and management, said patient related entities and said patients further collaboratively engaging with said healthcare providers and said healthcare provider related entities through said interactive platform;
developing a health planning recommendation including medical procedures and guidelines for said patients, said health planning recommendation defines a baseline for appropriateness of performance to evaluate performance beyond said recommended guidelines;
monitoring said patients for performance toward said recommended guidelines in view of an health assessment output as obtained from said health assessment module;
generating an alarm when said monitored performance is beyond an acceptance range of said baseline; and
communicating information about said performance of said patients to said respective patient related entities, wherein said patient related entities are dynamically selected based on an associated relational score and nature of association of said patient related entities with said respective patients,
wherein said patient related entities bear a relationship with said respective patients as defined by an associated relationship identity number associated with each of said patient related entities in association with said respective patients.

17. The program storage device of claim 16, wherein said method further comprises assigning said relational score to said patient related entities in association with said respective patients based on parameters including one or more of natural relationship, familiarity of said patient related entity with said medical problem of said patient, historical association of said patient related entity, age of said patient related entity, acceptance of said patient related entity by said patient as caretaker, affinity or proximity toward said patient, and ethical intent, and wherein a weightage is associated with each of said parameters such that a cumulative relational score is defined based on relational scores for each of said parameters weighted with said respective weightage scores.

18. The program storage device of claim 17, wherein said method further comprises using said cumulative relational score to define or update criteria for scoring of subsequent patient related entities, and wherein a historical record of said relational scores of said patient related entities scored in said past being used to dynamically update said subsequent scoring of said patient related entities in real time.

19. The program storage device of claim 16, wherein said patient related entities include one or more of parents, guardians, kids, siblings, colleagues, teachers, caretakers, and doctors, each of them being scored differently for assigning said relational score.

20. The program storage device of claim 16, wherein said baseline for appropriateness further identifies a range with an upper limit of appropriateness and a lower limit of appropriateness, said method further comprising updating said range of appropriateness and said baseline dynamically based on an input from said clinical data repository and said patient information database, wherein said patient related entities are informed about said dynamic updates based on their relational score and said nature of association.
